(19) United States
(12) Patent Application Publication
(10) Pub. No.: US 2022/0170867 A1
(43) Pub. Date: Jun. 2, 2022

(54) TESTING DEVICE AND METHOD FOR MEASURING THE HOMOGENEITY OF AN OPTICAL ELEMENT

(71) Applicant: Carl Zeiss Meditec AG, Jena (DE)

(72) Inventor: Beate BÖHME, Großpürschütz (DE)

(73) Assignee: Carl Zeiss Meditec AG, Jena (DE)

(21) Appl. No.: 17/442,941

(22) PCT Filed: Mar. 30, 2020
(86) PCT No.: PCT/EP2020/058905

§ 371 Date: Sep. 24, 2021

(30) Foreign Application Priority Data
Apr. 1, 2019 (DE) 10 2019 204 578.2

(51) Int. Cl. G01N 21/958; G02B 27/00; G01N 21/45

(52) U.S. Cl. CPC G01N 21/958; G01N 2021/9583; G01N 21/45; G02B 27/0025

(57) ABSTRACT

A testing device for measuring the homogeneity of an optical element in a beam path of the testing device and related method. The testing device includes an interferometer, which comprises a monochromatic light source, an adjustable objective, a reference surface associated with a surface of the optical element to be tested or an interferometry surface, and an analysis unit for the interference of the wave fronts of the light reflected by the reference surface and the associated surface of the optical element to be tested or of the interferometry surface. The testing device and method facilitate highly precise measurement of the homogeneity of an entire optical element—not merely individual surfaces. The method is suitable for the highly precise measurement of plastic lenses or other injection molded components for refractive laser eye surgery for example.

### RELATED APPLICATIONS

This application is a National Phase entry of PCT Application No. PCT/EP2019/081926 filed Nov. 20, 2019, which application claims the benefit of priority to DE Application No. 10 2018 219 902.7 filed, Nov. 21, 2018, the entire disclosures of which are incorporated herein by reference.

### TECHNICAL FIELD

Embodiments of the invention relate to a test apparatus for measuring the homogeneity of an optical element in a beam path of the test apparatus containing an interferometer, the latter comprising a light source which emits monochromatic light which is coupled into the beam path via a beam splitter, an objective, a reference face which is assigned to a surface of the optical element to be tested or to an interferometry surface, and an analysis unit for the interference of the wavefronts of the light reflected by the reference face and the associated surface of the optical element to be tested or the interferometry surface. The present invention furthermore relates to a corresponding method for measuring the homogeneity of an optical element according to the principles of an interferometer and, in particular, a Fizeau interferometer: Fizeau interferometers and corresponding methods are usually used to determine the quality of a surface of an optical element.

### BACKGROUND

As a rule, optical elements are manufactured from very pure and very high-quality glasses, in particular quartz glasses. However, the production of optical elements made of plastic has also been promoted in recent years. An injection molding method is very often used in this context.

During the injection molding of optical elements, the heated, liquid plastic is injected into a volume, a so-called cavity. This is followed by an ejection and cooling process, during which the plastic solidifies. In the process, inhomogeneities arise in the volume of the optical elements both as a result of the injection and as a result of the cooling, and cause a spatial variation in the refractive index. The wavefront of the incident light is deformed and so the imaging quality reduces as a result of the installation of such optical elements in optical systems and, for example if used in a system operating with focused laser radiation, there is an increase in the size of the laser focus generated.

Methods and arrangements for measuring the homogeneity of large glass blocks are known from the literature. The measurement is implemented by interferometry, sometimes with immersion (using oil), and by combining a plurality of measurements by calculation. Furthermore, use is made of a reference face and an interferometry surface. There is a high lateral resolution on account of the possible number of camera pixels and path length differences of fractions of the wavelength are measurable. However, all these methods require samples that have be polished to be planar (“wedges”) and/or the arrangement of the sample in immersion, as well as a planar interferometry surface arranged downstream of the glass block. As a result, the measurement is very complex overall.

On the other hand, only the surfaces of the optical elements, in particular of lenses, are measured in the case of non-planar elements in particular. No solution is known for measuring the homogeneity in the volume of lenses with interferometric accuracy.

The literature has disclosed Shack-Hartmann sensors for lenses with at least one curved face (Su et al, Refractive index variation in compression molding of precision glass optical components, Applied Optics, Vol 47, No. 10, 2008). In this case, the variations of the wavefront are analyzed in order to deduce variations in the refractive index therefrom. In comparison with interferometry, this measuring method has a significantly lower accuracy (i.e., the minimal path length difference that can be measured is significantly longer) and a lower lateral spatial resolution, the latter being limited by the number of lenses in the sensor. Furthermore, this also requires an immersion, the inhomogeneities of which can also interfere with the measurement and which is complicated in terms of handling. Moreover, the influence of the inhomogeneities present in the volume cannot be separated from the influence of the inhomogeneities of the surface in the case of the transmission measurement.

It is therefore an object of the present invention to provide a test apparatus and a method for highly precisely measuring the homogeneity of an optical element—not only of individual faces but the totality of the optical element—which, in particular, is also suitable for the highly precise measurement of plastic lenses or other injection molding components for refractive laser eye surgery where highest quality and timely intervention should production problems arise are decisive, and which moreover is simple to handle.

Embodiments of the invention include a test apparatus for measuring the homogeneity of an optical element in a beam path of the test apparatus containing an interferometer. In this case, the interferometer of the test apparatus comprises a light source which emits monochromatic light. As a rule, this is a laser light. In this case, the beam emitted by the light source is coupled into the beam path via a beam splitter.

The interferometer of the test apparatus furthermore comprises an adjustable objective, which is usually also interchangeable and variable in respect of its individual objective elements and variable in terms of its position in the beam path.

The interferometer furthermore contains a reference face, which may be the last surface in the beam path of the interferometer and which is assigned to a surface of the optical element to be tested. The object lies in generating interferences of the light reflected by the reference face with the light reflected by the surface of the optical element to be tested that is associated with the reference face and, from disturbances in interferences, deducing defects of the optical element to be tested.

Arranging the reference face at the end of the beam path is advantageous in that influences that may arise due to other elements situated in the beam path between the optical element to be tested and the reference face and that may lead to further disturbances in the interference are minimized. However, naturally, it is also possible to arrange the reference face at other points in the beam path, for example downstream of the beam splitter at the point where light is coupled into or coupled out of the beam path.

Finally, the interferometer of the test apparatus also comprises an analysis unit for analyzing the interference of the wavefronts of the light reflected by the reference face and by the associated surface of the optical element to be tested. Such an analysis unit contains an apparatus for data processing and for example also an imaging apparatus such as a monitor. By way of example, such an analysis unit can be realized by use of a CCD camera. However, in communication with the latter there can be a further apparatus for data analysis, which ascertains more detailed information—such as the extent and position of surface defects, for example—from the image representations of the interference of the wavefronts of the light reflected by the reference face and by the associated surface of the optical element to be tested.

The optical element which is arranged in the beam path of the test apparatus and which for example is a lens element comprises a surface that faces the test apparatus and a surface that faces away from the test apparatus.

According to example embodiments of the invention, the reference face now is assigned to the surface of the optical element that faces away from the test apparatus. This corresponds to a test set up which is completely different from what is otherwise conventional, for example, in a Fizeau interferometer: Since a Fizeau interferometer should be used to determine surface defects of a surface of an optical element, the surface to be tested usually faces the test apparatus in that case. Ideally, the reference face and the surface to be tested are directly opposite one another in Fizeau interferometry, and also in other interferometry arrangements.

By contrast, the test apparatus according to the invention ensures that the light enters into the optical element to be tested through the surface of the optical element that faces the test apparatus, passes through the volume of the optical element and is reflected at the surface of the optical element (the lower side thereof) that faces away from the test apparatus. Then, the light passes through the volume of the optical element again on its return path to the interferometer. Therefore, the surface of the optical element to be tested that faces away from the test apparatus can also be understood to be an interferometry surface. As a result, the (optically effective) homogeneity is tested according to the invention, said homogeneity being a summary homogeneity or overall homogeneity and said homogeneity including the surface defects or defects of, or disturbances in, the homogeneity of the two surfaces of the optical element and of the volume.

This is relatively trivial if the optical element to be tested is an optical element with planar surfaces. This is more difficult if this surface of the optical element to be tested that faces away from the test apparatus is non-planar but nevertheless yields precise results if, either, the interference is analyzed by appropriate (as a rule automated) data analysis and/or further measures are taken in order to be able to make a reliable statement regarding the homogeneity of the optical element from the interference of the radiation reflected from the reference face and from the surface of the optical element to be tested that faces away from the test apparatus. The precondition according to the invention to this end is an assignment of the reference face to this surface that faces away from the test apparatus and hence a corresponding configuration and positioning of the reference face such that interferences of the reflected radiation, i.e., of the wavefronts of the light reflected at the two faces, is rendered possible as a matter of principle. A reference face of a curved surface of a lens element that faces away from the test apparatus will likewise be curved in the interferometer. Thus, as a rule, the reference element is “calculated” according to the ideal surface of the optical element to be tested that faces away from the test apparatus and is embodied with an appropriate shape.

Accordingly, the homogeneity of the optical element can easily be measured in air using the test apparatus according to the invention. Hence, the interferogram measured in the analysis unit of the interferometer contains the defects of both the two surfaces and the volume, and, in summary manner, provides a statement relating to the homogeneity of the optical element.

Such a statement relating to the homogeneity of an optical element is a great help when such optical elements are produced from plastic, in particular when the optical element is produced by application of an injection molding method, since extended disturbances in the homogeneity in the volume of the optical element may occur during the production process in the case of process problems, and the surfaces can also have corresponding defects. Nevertheless, the method can likewise be applied to optical elements made of glass, in particular quartz glass, in order to be able to make a statement about the homogeneity, and hence the quality, of the optical element in the same way.

However, as already indicated, such a significant aberration (a spherical aberration in the case of a lens element) usually occurs when the test apparatus according to the invention as described here is used that the interferograms are only evaluable with difficulties and, as a rule, an apparatus for data analysis is required to be able to interpret the interferogram and consequently be able to make a statement about the homogeneity of the tested optical element. Therefore, improving the interpretability of the interferogram and hence facilitating a statement even without a high-resolution automated data analysis is a further object in this case.

In a particular example configuration of the test apparatus according to the invention, the latter furthermore comprises an optical compensation element which is arrangeable in the beam path between interferometer and optical element to be tested. This optical compensation element is configured to compensate a monochromatic aberration due to the specified geometry of the optical element. This compensation element is actually arranged in the beam path when measuring the homogeneity of the optical element but, in turn, it is exchangeable for another compensation element if the geometry changes for a next optical element to be tested and its position is able to be changed.

As a rule, the optical compensation element will be a compensation lens if the optical element to be tested is a lens element. However, an optical compensation element can also be computer-generated hologram (CGH). Here, the compensation by use of the optical compensation element is implemented in such a way that the wavefront returning from an ideal lens element to be tested is approximately spherical. In a certain way, the compensation element complements the optical element to be tested: A planoconcave lens as optical element to be tested works with a planoconvex lens, a biconvex lens with a biconcave lens, etc. This is advantageous for example in that these lens elements are very much more cost-effective than a computer-generated hologram.

When a compensation lens is used for the measurement of a lens element to be tested, the (monochromatic) aberration to be minimized or removed or altered is a spherical aberration. In this way, the wavefront entering into the interferometer having come back from an ideal lens element to be tested is approximately spherical. Lens elements with a deviation of the wavefront from this spherical form can be found to be outside the tolerance range in one step by way of a simple visual inspection of the interferogram.

An alternative test apparatus for measuring the homogeneity of an optical element in a beam path of the test apparatus containing an interferometer, the latter having a light source which emits monochromatic light, in particular laser light, which is coupled into the beam path via a beam splitter, an adjustable objective, a reference face, for example as last surface in the beam path of the interferometer, and an interferometry surface downstream of the optical element to be tested. Here, the reference face is assigned to the interferometry surface. The test apparatus furthermore comprises an analysis unit for the interference of the wavefronts of the light reflected by the reference face and the assigned interferometry surface.

According to the invention, this alternative test apparatus furthermore comprises an optical compensation element which is interposable in the beam path between the optical element to be tested and the interferometry surface (and which is actually arranged in the beam path when measuring the homogeneity of the optical element) and which is set up to compensate a monochromatic aberration due to the specified geometry of the optical element, in such a way that the light emitted by the light source passes through the optical element to be tested and the compensation element before and after it has been reflected at the interferometry surface. As a result, both a summary homogeneity or overall homogeneity of the optical element to be tested, which includes the surface defects or defects of, or disturbances in, the homogeneity of the two surfaces of the optical element and of the volume, is determined and the interference image which allows a statement to be made in respect of this homogeneity is rendered “readable” in simple and reliable way by visual inspection.

In this alternative test apparatus, the interferometry surface is realized in a simple embodiment by a surface of the compensation element that faces away from the test apparatus. Thus, the compensation element adopts two functions in this embodiment: The compensation of the monochromatic aberration which arises due to the geometry of the optical element to be tested and the making available of a face—in the form of the surface that faces away from the test apparatus—at which the light that passes through the optical element to be tested and through the compensation element is reflected and transmitted back along the same path in order to interfere with light reflected by the reference face.

Furthermore, it is advantageous for example if the optical compensation element in the test apparatus according to the invention is interposable in the beam path near the optical element to be tested, in such a way that a geometric distance that is as small as possible is obtained between the optical compensation element and the optical element to be tested: Then, there is approximately exact compensation of the two aberrations, related to the surface of the optical element to be tested that faces the test apparatus and the surface of the compensation element that faces the optical element to be tested. This applies both to an arrangement of the compensation element between the interferometer and the optical element to be tested and to an arrangement downstream of the optical element to be tested.

A test apparatus according to the invention, the optical compensation element of which has the shape of a planoconvex lens, is advantageous for example for an optical element to be tested, which has the shape of a planoconcave lens. Here, the concave surface of the planoconcave lens to be tested is the surface that faces away from the test apparatus. Then, the planar surface of the planoconvex lens as compensation element is arranged on the planar surface of the planoconcave lens to be tested, which is the surface that faces the test apparatus.

Here, in an example arrangement, the light is reflected at the concave surface of the planoconcave lens to be tested. The creation of installation space for actuators and sample holders is advantageous, also in general terms for such an arrangement in the test apparatus, since the optical element to be tested is the last element in the beam path. Furthermore, the use of the planoconcave surface of the planococave lens to be tested in reflection increases the sensitivity of the interferogram in relation to defects of this face by a factor of approximately 3 in relation to the use of another face as interferometry surface.

In a special configuration of the test apparatus according to the invention, the optical element to be tested is a contact element for refractive laser eye surgery. A contact element in refractive eye surgery, which is also referred to as contact glass or patient interface, is in this case a central element in a procedure of refractive laser eye surgery: Using such a contact element, the relative position of a patient's eye is fixed relative to a laser applicator during such a surgical procedure: The (generally concave) surface is in this case placed directly on the patient's eye to be treated and affixed by application of negative pressure, for example. Hence, the contact element is the last optical element in a beam path of an ophthalmological laser surgery device. The treatment laser beam is guided in the cornea of the patient's eye in very close proximity to the contact element. (Optically effective) disturbances in the homogeneity have a particularly severe influence at this point, which is why the homogeneity of the contact element must not only be tested particularly carefully during the production process thereof but also in an uncomplicated manner at the same time. In particular, this is important if an injection molding method is used for the production of such a contact element.

Found to be particularly advantageous for example is a test apparatus according to the invention, which furthermore comprises an ideal optical reference element, which is interposable in the beam path of the test apparatus instead of the optical element to be tested, and which is configured to carry out a reference measurement on the ideal optical reference element. This reference measurement is then subtracted from a subsequent measurement of the optical element to be tested.

In this way, it is possible to ascertain a deviation from an ideal homogeneity and hence also possible to provide a decision template for accepting or rejecting the tested optical element. Here, the evaluation of the measurement of the optical element to be tested in comparison with the reference element is implemented, as a rule, in the analysis unit.

A simple evaluation is possible, in particular, if the optical element to be tested can be positioned in the test apparatus according to the invention non-concentrically and with a defined deviation relative to the test apparatus. An interference image generated thus, which for example has regular straight fringes in this case, can be evaluated particularly easily: In the case of deviations from an “ideal optical element” or from the reference element, disturbances in the linearity of the fringes which result from disturbances in the homogeneity of the optical element to be tested can easily be identified.

In an example configuration of the test apparatus according to the invention which serves to be able to further distinguish, according to their causes, the disturbances arising in the homogeneity of the optical element to be tested and which serves to immediately identify particularly critical disturbances, the test apparatus is embodied to subtract low-frequency defects of the homogeneity (i.e., inhomogeneities of the volume and/or surface defects) in order to render high-frequency defects of, or disturbances in, the homogeneity identifiable.

Here, low-frequency defects are low order Zernike polynomials. Such an analysis is particularly advantageous for example if contact elements for refractive laser eye surgery should be tested. As already mentioned above, the treatment focus is close to the contact element or contact glass in the case of laser surgery or laser therapy on the eye. Here, high-frequency inhomogeneities or surface defects are particularly bothersome. Therefore, in that case, the Zernike polynomials for defocus, astigmatism, coma and spherical aberration Z9, in particular, are subtracted. At the same time, this allows influences of an imprecise centering of compensation element and optical element to be tested, in this case the contact element, to be eliminated. Once again, the evaluation in this respect of the measurement of the optical element to be tested is implemented, as a rule, in the analysis unit.

Equally, it is also possible to subtract all Zernike polynomials from Z1 to Z16 in order to extract even higher frequency inhomogeneities.

An example test apparatus according to the invention is embodied to separate components of disturbances in or defects of the homogeneity of the optical element caused by the surface that faces the test apparatus, the surface that faces away from the test apparatus and homogeneity defects in the volume of the optical element.

Thus, if testing the homogeneity of an optical element to be tested yields a deviation that is too large—such that, for example in the case of the repeated occurrence of such a deviation, the production of such optical elements, in particular of the above-described contact elements, needs to be interrupted—it is very advantageous for example for quickly finding the cause if, in a simple manner, it is possible to separate the components of disturbances in or defects of the homogeneity of the optical element caused by the surface that faces the test apparatus, the surface that faces away from the test apparatus and homogeneity defects in the volume of the optical element to quickly identify the step (or the steps!) in the production method of the optical element to be tested, which contributes to these disturbances.

As already mentioned, a quick and exact test of these optical elements is required, particularly when using plastics and/or an injection molding method for the production of the optical element to be tested. Thus, a test apparatus according to the invention is particularly advantageous if it is configured to test an optical element which comprises at least one plastic component and/or at least one injection molded component.

The object of the invention is also achieved by a method for measuring the homogeneity of an optical element according to the principles of an interferometer, in which an interference of the wavefronts of reflected light from a reference face and an associated surface of the optical element to be tested is generated, characterized in that the surface of the optical element to be tested, which is associated with the reference face, is arranged in a beam path of the interferometer in such a way that the light used for the measurement has to pass the optical element to be tested in order to be reflected at the surface associated with the reference face. If use is made of an appropriate reference face as already described above, this optical element to be tested can have non-planar surfaces if an interference image arising as a result is analyzed by automated data analysis and/or if a further measures are taken in order to render the interference image “readable” by the naked eye. Therefore, the method according to the invention is also suitable for curved faces like those of lens elements.

Instead of a measurement of a surface of the optical element to be tested for the purposes of determining surface defects of this one surface, as was previously conventional in Fizeau interferometry for example, the method according to the invention is used to make a statement regarding the homogeneity of the optical element in summary manner since, in that case, the light passes through the optical element to be tested in order then to be reflected at the (lower side of the) surface associated with the reference face, defects or disturbances of the two surfaces and of the entire volume of the optical element to be tested become “active” and visible in the in the interferogram of this optical element to be tested with the reference face.

The method according to an example embodiment of the invention is therefore suitable by way of a single, simple measurement to provide a statement regarding the homogeneity of the optical element to be tested, as is required particularly after the production of such optical elements from plastic, in particular when producing the optical element by application of an injection molding method, and as is helpful even in the case of optical elements made of glass, in particular quartz glass.

This is a contactless method for measurement in air (i.e., without immersion) such that the optical element can be exchanged, centered and measured in an automated process. In this way, moderate outlay facilitates high-speed, non-destructive testing of 100% of such elements in an automated production thereof, for example of lens element and, in particular, contact elements for refractive laser surgery.

On account of very high aberrations and the inability of the human eye to interpret interferograms in this state, the evaluation of said interferograms generated by the method according to the invention is difficult. In this case, these should be implemented supported by an automated data analysis in order to make a reliable statement about the homogeneity of the tested optical element. A simplification of the interpretability of the interferogram in order to facilitate a reliable statement even without an automated data analysis is therefore still desirable.

In a particular example method according to the invention, a monochromatic aberration due to the specified geometry of the optical element to be tested is therefore compensated. Such a compensation is usually implemented by the introduction of a compensation element into the beam path between the test apparatus and the optical element to be tested, for example a compensation lens if the optical element to be tested is a lens element. However, it is also possible to achieve a compensation by use of an appropriate computer-generated hologram (CGH). The object of such compensation is to make the wavefront returning from an ideal (disturbance- or defect-free) lens element to be tested return along the same path traversed up to the reflection by the emitted wavefront.

In each case, the compensation element complements the optical element to be tested: A planoconcave lens as optical element to be tested works with a planoconvex lens, a biconvex lens with a biconcave lens, etc. In this way, the wavefront returning from an ideal lens element to be tested is approximately spherical, for example. Lens elements with a deviation of the wavefront from this spherical form can be found to be outside the tolerance range in one step by way of a simple visual inspection of the interferogram.

In an alternative method for measuring the homogeneity of an optical element according to the principles of an interferometer, in which an interference of the wavefronts of the reflected light from a reference face and an interferometry surface is generated, the optical element to be tested is arranged in a beam path of the interferometer in such a way that the light used for the measurement passes through the optical element to be tested, both before and after it has been reflected at the interferometry surface, and moreover a monochromatic aberration occurring as a result of the specified geometry of the optical element is compensated. This can be implemented by calculation by way of a computer-generated hologram (CGH) or physically for example by the use of a compensation element which is arranged in the beam path between optical element and interferometry surface if an interferometry surface is used in the beam path downstream of the optical element to be tested.

In a method according to an example embodiment of the invention, it is advantageous for example, for the purposes of compensating the monochromatic aberration, to arrange an optical compensation element in the beam path at the smallest possible distance from the optical element to be tested so that an approximately perfect compensation can be obtained for the two aberrations at the surface of the optical element to be tested, through which the light enters into the optical element to be tested and through which it emerges again on the return path as well, and at the surface of the compensation element that faces the optical element to be tested.

Furthermore, it simplifies a method according to the invention if initially an ideal optical reference element is measured, the data of which are recorded (i.e., registered, stored and/or graphically represented) as a reference measurement, then the optical element to be tested is measured, the data of which are recorded as measurement of the optical element to be tested, and finally the data of the reference measurement are subtracted from the data of the measurement of the optical element to be tested.

This facilitates ascertainment and representation of a deviation from an ideal homogeneity and facilitates a simple decision about acceptance or rejection of the tested optical element.

Moreover, a method according to the invention is advantageous for example, in which the optical element to be tested is positioned with a defined deviation and non-concentrically in relation to a test apparatus which implements the principle of the interferometer.

This can be a defined parallel displacement of the optical axis of the optical element to be tested with respect to the optical axis of a test apparatus or a different deviation from concentricity. The object is to render an interference image of the interference of the wavefronts from the optical element to be tested and from the reference element easily evaluable, i.e., for example to generate an interference image of regular straight fringes which have disturbances in the linearity of the fringes in the case of a deviation from an ideal optical element/reference element.

Additionally, an evaluation of the measured homogeneity of an optical element is simpler and more precise if low-frequency defects of the homogeneity are subtracted in a method according to the invention in order to render high-frequency defects of the homogeneity identifiable.

As already mentioned, low-frequency defects are low order Zernike polynomials. If these defects are subtracted, this renders particularly bothersome high-frequency inhomogeneities or surface defects visible. At the same time, this allows influences of an imprecise centering of compensation element and optical element to be tested, in this case the contact element, to be eliminated.

If relatively large defects or disturbances in the homogeneity of the optical element occur, it is particularly advantageous for example to complement the method according to the invention by way of allowing the components of the homogeneity of the optical element from the two surfaces and the volume of the optical element to be separated by virtue of implementing two further (i.e., additional) measurements according to the original principles of interferometry, in particular a Fizeau interferometer:
In a first additional measurement, a first new reference face is assigned to a first surface which represents the original light-entry surface of the optical element to be tested, in order to represent the surface defects of this first surface. In this case, the light used for the measurement is incident on this first surface of the optical element and reflected there. The light reflected at this first surface, which light is suitable to interfere with the light reflected at the reference face, therefore no longer passes through the volume of the optical element to be tested.
In a further additional measurement, the optical element to be tested is rotated through 180° and, once again, a reference face is assigned to a second surface of the optical element to be tested (which in principle corresponds to the reference face of the measurement of the summary homogeneity of the optical element to be tested, which was implemented with the basic method that simultaneously characterizes the volume and the surface of the optical element) in order to represent the surface defects of this second surface. In this case, too, the light used for the measurement then is incident on this second surface of the optical element and is reflected there. It likewise no longer passes through the volume of the optical element to be tested in order to interfere with the light reflected at the reference face.
Subsequently, these two additional measurements are combined by calculation with the original measurement in order to represent the homogeneity of the volume of the optical element to be tested.

Thus, if the accuracy of the measurement is important instead of a fast measurement of the homogeneity and if the influences of defects or disturbances in the volume of the optical element to be tested and surface defects of the optical element to be tested are required separately, these can be easily ascertained by way of the additional method steps described here.

### BRIEF DESCRIPTION OF THE DRAWINGS

The present invention should now be explained in more detail by example embodiments. In the drawing:

FIG. 1a depicts a first exemplary embodiment of a test apparatus according to the invention;

FIG. 2a depicts an interferogram generated by operation of the first test apparatus;

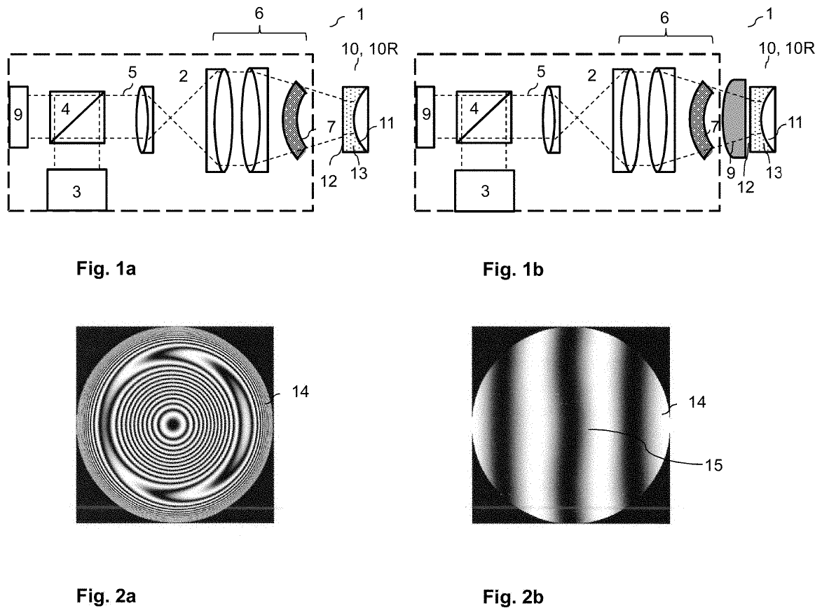

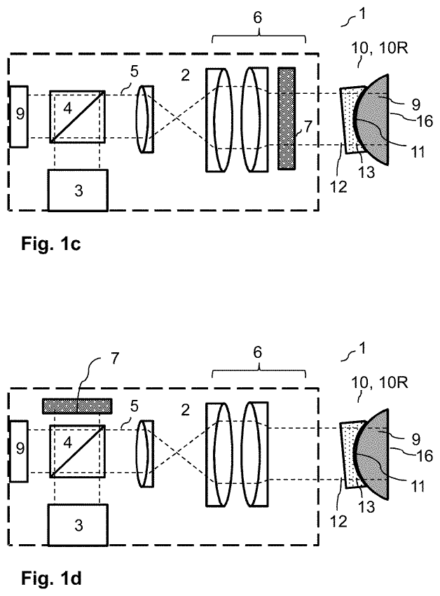

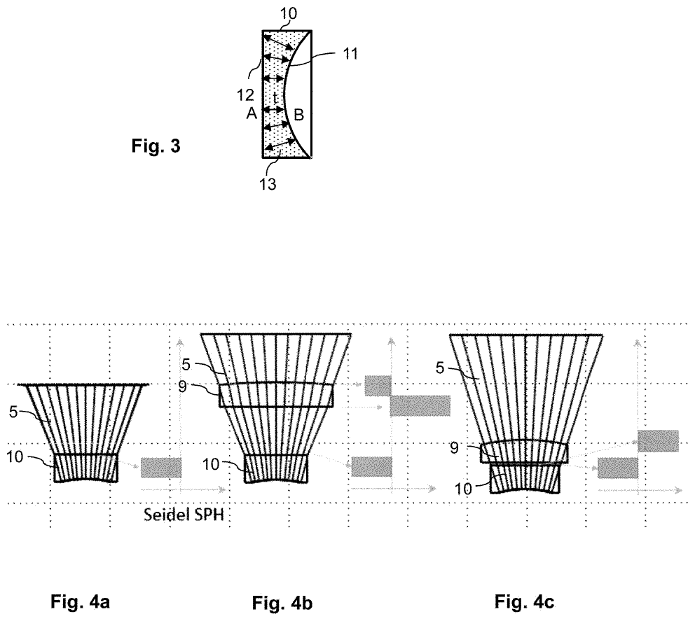

FIG. 1b depicts a second exemplary embodiment of a test apparatus according to the invention;

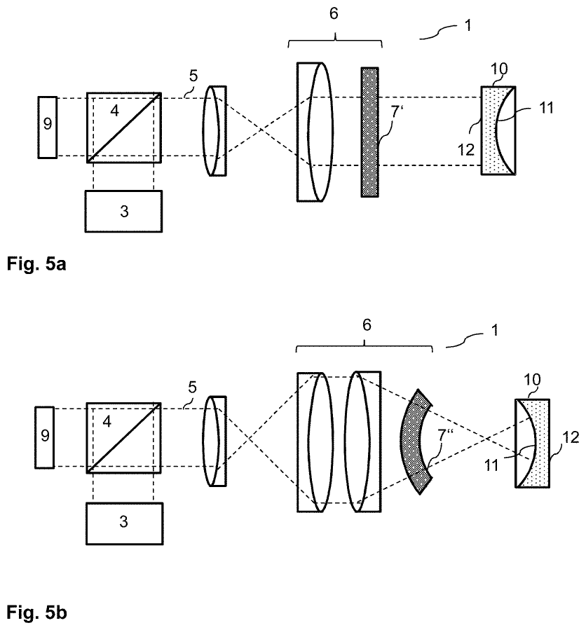

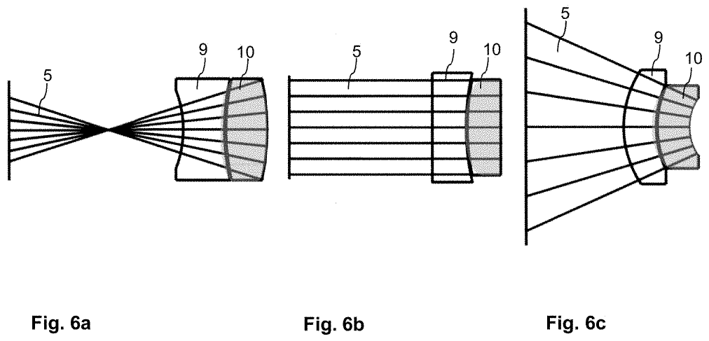

FIG. 2b depicts an interferogram generated by operation of the second test apparatus;

FIG. 1c depicts a third exemplary embodiment of a test apparatus according to the invention;

FIG. 1d depicts a fourth exemplary embodiment of a test apparatus according to the invention;

FIG. 3 depicts an optical element to be tested;

FIGS. 4a to 4c each depict different setups of an optical element to be tested and its compensation element;

FIGS. 5a and 5b depict the use of a test apparatus according to the invention for separating the components contributing to the homogeneity of the optical element to be tested;

FIGS. 6a to 6c depict different types of optical elements and their compensation elements.

### DETAILED DESCRIPTION

FIG. 1a illustrates a first example embodiment of a test apparatus 1 according to the invention for measuring the homogeneity of an optical element 10. The test apparatus 1 contains an interferometer 2, the latter comprising a light source 3, which emits monochromatic light in the form of the laser beam which is coupled into the beam path 5 of the interferometer 2 via a beam splitter 4, an objective 6 which is adjustable and exchangeable and which contains a reference face 7 which in this case is arranged as last surface in the beam path 5 of the interferometer 2 and which is assigned to a surface of the optical element 10 to be tested, and an analysis unit 8 in the form of a CCD camera for the interference of the wavefronts of the light reflected by the reference face 7 and the associated surface of the optical element 10 to be tested. In this case, the positions of the light source 3 and the analysis unit 9 are interchangeable. Thus, there is equivalence between the interfering wavefronts transmitted back from the reference face 7 and the surface of the optical element 10 to be tested being guided through the beam splitter 4 to the analysis unit 8 or being deflected to an analysis unit 8 by the beam splitter 4 after the light source 3 has emitted the laser light through the beam splitter 4 to the optical element 10 to be tested. The interferometer may contain further elements, in particular also phase shifters for moving optical units and optical units for imaging the interfering wavefronts onto the CCD camera.

In the present case, the optical element 10 to be tested is a contact element for refractive surgery, i.e., a special planoconcave lens element made of plastic which must be produced with great precision in respect of its optical homogeneity and which is generated by application of an injection molding method. In this arrangement in the beam path 5 of the test apparatus 1, the optical element 10 comprises a surface 12 that faces the test apparatus 1, and in this case the interferometer 2 in particular, and a surface 11 that faces away from the test apparatus 1. According to the invention, the reference face 7 is assigned to the surface 11 of the optical element 10 that faces away from the test apparatus. In the specific case, this means that the reference face 7 likewise has concave curvature, in correspondence with the concave surface 11 of the lens elements 10 to be tested that faces away from the test apparatus 1. The laser beam emanating from the light source 3 of the interferometer 6 therefore passes through the surface 12 of the lens element 10 to be tested that faces the test apparatus 1, furthermore passes through the volume 13 of the lens element 10, is reflected at the lower side of the side 11 of the lens element 10 that faces away from the test apparatus 1, once again passes through the volume 13 and the surface 12 of the lens element 10 to be tested that faces the test apparatus 1 in order to interfere with the part of the laser beam reflected at the reference face 7. The returning, interfering wavefronts are steered through the beam splitter 4 to the analysis unit 9, i.e., the CCD camera, and lead to an interferogram 14 at this point.

A corresponding interferogram 14, which is generated by operation of the first test apparatus 1 according to the invention when measuring the planoconcave lens element 10, is shown in FIG. 2a. The occurrence of a high spherical aberration is identifiable, and so the interference image in the interferogram 14 cannot be assessed by the naked eye or can only be assessed by a very experienced observer. In this case, this can usually only be evaluated reliably by an automated data analysis. In the case of very high spherical aberrations, the interference rings in one part of the interferogram attain such a high spatial frequency that they are no longer detectable (resolvable) even using a conventional CCD camera: An automated data analysis is no longer possible if, to this end, an appropriate high resolution of the interference image is no longer available, for example if the CCD camera has too few pixels. Then, very much outlay is required in order to obtain an appropriate resolution, i.e., an appropriate number of pixels.

FIG. 1b shows a second example embodiment of a test apparatus 1 according to the invention. With the exception of one detail, this second exemplary embodiment corresponds to the structure of the first, above-described exemplary embodiment of the test apparatus 1 according to the invention: It additionally comprises an optical compensation element 9, which is arrangeable (and arranged in this case) in the beam path 5 between the reference face 7 and the optical element 10 to be tested. Like the objective 6 and also the reference face 7, the optical compensation element 9 is exchangeable in such a way that it is possible to arrange in the beam path a compensation element 9 that fits to the optical element 10 to be tested in each case.

This optical compensation element 9 compensates one or more monochromatic aberrations due to the specified geometry of the surface 12 of the optical element 10 that faces the test apparatus. In the present case of this example embodiment, in which a planoconcave lens element 10 should be measured, the optical compensation element 9 is a planoconvex lens.

FIG. 2b now illustrates an interferogram 14 generated by operation of the second test apparatus 1. An interference image with regular straight fringes arises for an ideal optical element 10 (i.e., an optical element without defects or disturbances) as a result of an additional slight deviation from the concentricity between the test apparatus 1 and the optical element 10 to be tested, i.e., the planoconcave lens element in this case. In the case of deviations from an ideal optical element or reference element, i.e., if defects or disturbances occur (for example, bracing which is likewise optically effective), deviations 15 from the linearity of the interference fringes are identifiable in the interference image.

In order to render the measurement of the homogeneity even better evaluable, it is also possible in the example embodiment described here to initially carry out a reference measurement using an ideal optical element, i.e., an ideal lens element 10R in this case—with the same planoconvex lens as compensation element 9 that is subsequently used for measuring the lens element 10 to be tested. Then, the ideal lens element 10R is replaced by the lens element 10 to be tested, the latter is measured in the same way, and both measurements are subtracted from one another.

FIG. 1c shows a third example embodiment of a test apparatus 1 according to the invention, as an alternative to the second example embodiment. In this exemplary embodiment, the compensation element 9 is arranged in the beam path 5 directly downstream of the optical element 10 to be tested such that the surface 11 of the optical element 10 to be tested that faces away from the test apparatus and the surface of the compensation element 9 that faces the test apparatus are in contact over the entire area. Moreover, the surface 16 of the compensation element 9 that faces away from the test apparatus forms the interferometry surface to which the reference face 7 is assigned. Since such a surface 16 of the compensation element 9 that faces away from the test apparatus is freely selectable as a rule, it can for example be embodied in such a way that a planar reference face 7 can be used. If the optical element 10 to be tested contains a planar surface 12, the surface 16 of the compensation element will particularly advantageously for example likewise have a planar embodiment.

The optical element to be tested is arranged downstream of the test apparatus 1 in the beam path 5 such that light used to measure the optical element passes therethrough, as is also still the case for the compensation element 9, in order to be reflected at the surface 16 of the compensation element 9 that faces away from the test apparatus 1, i.e., at the interferometry surface. The light passes through the optical element 10 to be tested and through the compensation element 9 in such a way that there are no further interferences that are detectable by an analysis unit 8 than the interferences between the wavefronts of the light reflected at the interferometry surface 16 and at the reference face 7. These interferences provide information about the homogeneity of the optical element 10 to be tested since the light has passed through this element (forward and back) along its path to the interferometry surface. Disturbances and defects in the volume 13 or at the surfaces 11, 12 of the optical element 10 become noticeable by way of corresponding irregularities 15 in the interferogram 14, as already shown in FIG. 2b, and are easily visible on account of the use of the compensation element 9.

FIG. 1d shows a fourth example embodiment of a test apparatus 1 according to the invention, which in principle corresponds to the third example embodiment in terms of arrangement and function and the only difference is that in this case the reference face 7 is arranged downstream of the beam splitter 4. Nevertheless, completely comparable interferences between the light reflected at the surface 16 that faces away from the test apparatus 1, i.e., the interferometry surface, and the light reflected the reference face 7 become visible in the analysis unit.

FIG. 3 illustrates an optical element 10 to be tested, in this case a planoconcave lens element with two surfaces 11, 12 and the volume 13. If the light emitted by a test apparatus 1 now passes through a first surface 12 into the planoconcave lens element 10, passes through the latter and is reflected at the second surface 11, there is as a result a wave aberration W which is a function of the surface coordinates x, y perpendicular to the optical axis of the optical element to be tested, i.e., W(x, y), or else W(r, φ) if a description is implemented in polar coordinates r, φ:

W=A(n−1)+Bn+tΔn

Here moreover:
A, B: are the respective deviation of the first 12 or second surface 11 from an ideal surface. A and B are likewise a function of the surface coordinates x, y (or of the polar coordinates r, φ);
t: is the respective route (optical path), which extends perpendicularly or non-perpendicularly through the lens elements 10 depending on the position;
n: is the refractive index;
Δn: are the variations in the refractive index (likewise for the respective coordinates), which are an expression of the deviations of the homogeneity in the volume due to corresponding disturbances in the volume.

The result describes the deviation of the homogeneity of the optical element 10 to be tested, i.e., the lens element in this case which should be used as a contact element for laser eye surgery, from an ideal reference element. The influences of the deviations A, B of both surfaces 11, 12 and of the volume 13 Δn of the optical element 10 to be tested are measured in summary manner. The influence of the deviation B of the right-hand face 11, which adjoins the patient's eye during use in laser eye surgery and which is most critical during use, is however the greatest during a measurement using the method according to the invention. This applies, in particular, to the arrangement according to the invention as per FIG. 1a or 1b, in which this area 11 is used in reflection.

FIGS. 4a to 4c illustrate different setups, in each case of an optical element 10 to be tested, in this case a planoconcave lens element, and its compensation element 9. They show that it is particularly advantageous for example to arrange the compensation element 9, in this case a planoconvex compensation lens, as close as possible to the optical element 10 to be tested, as shown in FIG. 4c, because the spherical aberrations which arise at the two plane faces compensate one another almost exactly, and no defects are added at the other surfaces. For this reason, a residual error can be reduced to approximately 1/20th of the wavelength, and consequently has a negligible influence on the evaluation. By contrast, in FIG. 4a, in which work is carried out without compensation element 9, the defect of the plane face of the optical element 10 as the planoconcave lens element to be tested still exists. A significant defect likewise remains if compensation element 9 has a relatively large distance from the optical element 10 to be tested, as shown in FIG. 4b.

The geometry and arrangement of compensation element 9 and optical element 10 to be tested must be configured in such a way that there is an incidence that is as perpendicular as possible into the surface 11 of the optical element 10 that faces away from the test apparatus 1, at which surface the incident radiation should be reflected, so that the radiation takes the same path back.

In the case of lens elements 10 with a spherical configuration, the curvature of the surface at which the incident radiation should be reflected and the curvature of the associated compensation element 9 ideally have a common center.

FIGS. 5a and 5b show the use of a test apparatus 1 according to an example embodiment of the invention for separating the components of the two surfaces and the volume of the optical element 10 that contribute to disturbances in the homogeneity of the optical element 10 to be tested. To this end, there are two further (i.e., additional) measurements according to the original principles of the Fizeau interferometer:

In a first additional measurement, shown in FIG. 5a, a first new reference face 7′ is assigned to a first surface 12 which represents the original light-entry surface of the optical element 10 to be tested, in order to represent the surface defects of this first surface 12. In this case, the light used for the measurement is incident on this first surface of the optical element and reflected there, in order to interfere with the light reflected at the reference face. Therefore, it no longer passes the volume 13 of the optical element 10 to be tested.
In a further additional measurement, depicted in FIG. 5b, the optical element 10 to be tested is rotated through 180° and a reference face 7″ is once again assigned, the latter being the reference face of a second surface 11 of the optical element 10 to be tested (and, in principle, corresponds to the reference face 7 which was used when measuring the summary homogeneity of the volume 13 and the two surfaces 11, 12 in the main method), in order to represent the surface defects of this second surface 11. In this case, too, the light used for the measurement is incident on this second surface 11 of the optical element and reflected there, in order to interfere with the light reflected at the reference face. It likewise no longer passes the volume 13 of the optical element 10 to be tested.
Subsequently, these two additional measurements are subtracted from the original measurement (as obtained in the main method) in order to represent the homogeneity of the volume 13 of the optical element 10 to be tested.
   For a greater accuracy, the subtraction of the measurements can contain additional scalings which take account of the optical paths illustrated in FIG. 3 and/or contain the refractive index.

Thus, if the accuracy of the measurement is important instead of a fast measurement of the (summary) homogeneity and if the influences of defects or disturbances in the volume of the optical element to be tested and surface defects of the optical element to be tested are required separately, this can be easily ascertained by way of the additional method steps described here.

Here, the arrangements of FIGS. 5a and 5b for the additional measurements of the surface defects of the two surfaces 11, 12 of the optical element 10 correspond to conventional interferometry arrangements. As shown here, when measuring a planoconcave lens element 10, a plane surface is used as a reference face 7′ for measuring the planar surface 12 and a spherical reference face 7″ is used for the spherical (concave) surface 11. Hence, in the equation for W specified above, it is possible to insert A and B and the homogeneity of the volume arises after reformulating the equation. In an alternative interferometer, the reference face can also be arranged downstream of the beam splitter, as illustrated in FIG. 1d.

Finally, FIGS. 6a to 6c show different types of optical elements 10 to be tested and their compensation elements 9 in a beam path 5 of a test apparatus 1.

For measuring the homogeneity of various other conventional lens elements 10, these are arranged with similar compensation lenses 9: This is illustrated in FIGS. 6a to 6c for a biconvex lens, a planoconvex lens and a meniscus-shaped lens. As already described above, all lens elements 10 to be tested and compensation lenses 9 are arranged such that they are located as close together as possible or, in the ideal case, in contact with one another. Furthermore, the second face of the compensation lens 9 is arranged such that it is approximately concentric with the second face of the lens element 10 to be tested such that the light is not refracted and deflected there. The two lenses from FIGS. 6a and 6c can be used in the arrangement as per FIG. 1b instead of the lenses 9, 10. The two lenses from FIG. 6b can be used in the arrangement as per FIGS. 1c, 1d. An advantage here is that the light from the interferometer is reflected at the surface of the optical element (10) that faces away from the test apparatus such that this face has a dominant component in the interferogram. If the interferometry face should alternatively be located in the compensation element, then the function of the lenses 9 and 10 can also be interchanged in FIGS. 6a, 6b, 6c.

The aforementioned features of the invention, which are explained in various example embodiments, can be used not only in the combinations specified in an exemplary manner but also in other combinations or on their own, without departing from the scope of the present invention.

A description of an apparatus relating to method features is analogously applicable to the corresponding method with respect to these features, while method features correspondingly represent functional features of the apparatus described.

1.-42. (canceled)

43. A method for measuring homogeneity of an optical element having at least one non-planar surface according to principles of an interferometer, the method comprising:
generating interference of wavefronts of reflected light from a reference face that is not part of the optical element to be tested and an associated surface of the optical element to be tested;
arranging the surface of the optical element to be tested, which is associated with the reference face, in a beam path of the interferometer in such a way that light used for measurement must pass the optical element to be tested in order to be reflected at the surface associated with the reference face.

44. The method as claimed in claim 43, further comprising compensating a monochromatic aberration by a specified geometry of the optical element to be tested.

45. A method for measuring homogeneity of a an optical element having at least one non-planar surface according to principles of an interferometer, the method comprising:
generating interference of wavefronts of the reflected light from a reference face and an interferometry surface;
arranging the optical element to be tested in a beam path of the interferometer in such a way that light used for measurement passes through the optical element to be tested, both before and after it has been reflected at the interferometry surface; and
compensating a monochromatic aberration occurring as a result of a specified geometry of the optical element.

46. The method as claimed in claim 44, further comprising, for the purposes of compensating the monochromatic aberration, arranging an optical compensation element in the beam path at a smallest possible distance from the optical element to be tested.

47. The method as claimed in claim 45, further comprising, for the purposes of compensating the monochromatic aberration, arranging an optical compensation element in the beam path at a smallest possible distance from the optical element to be tested.

48. The method as claimed in claim 43, further comprising:
first, measuring an ideal optical reference element and recording data of which as a reference measurement,
next, measuring the optical element to be tested, the data of which are recorded as measurement of the optical element to be tested; and
last, subtracting the data of the reference measurement from the data of the measurement of the optical element to be tested.

49. The method as claimed in claim 45, further comprising:
first, measuring an ideal optical reference element and recording data of which as a reference measurement,
next, measuring the optical element to be tested, the data of which are recorded as measurement of the optical element to be tested; and
last, subtracting the data of the reference measurement from the data of the measurement of the optical element to be tested.

50. The method as claimed in claim 43, further comprising positioning the optical element to be tested with a defined deviation and non-concentrically in relation to a test apparatus which implements the principle of the interferometer.

51. The method as claimed in claim 45, further comprising positioning the optical element to be tested with a defined deviation and non-concentrically in relation to a test apparatus which implements the principle of the interferometer.

52. The method as claimed in claim 43, further comprising subtracting low-frequency homogeneity defects to render high-frequency homogeneity defects identifiable.

53. The method as claimed in claim 45, further comprising subtracting low-frequency homogeneity defects to render high-frequency homogeneity defects identifiable.

54. The method as claimed in claim 43, further comprising
separating the components of defects of the homogeneity of the optical element caused by the two surfaces and the volume of the optical element by virtue of two further measurements being implemented according to the principles of interferometry, including
in a first additional measurement, assigning a first new reference face to a first surface which represents an original light-entry surface of the optical element to be tested, in order to represent the surface defects of this first surface,
in a further additional measurement, rotating the optical element to be tested through 180° and, once again, assigning a reference face to a second surface of the optical element to be tested, in order to represent the surface defects of this second surface,
combining the first additional measurement and the further additional measurement by calculation with the original measurement in order to constitute the homogeneity of the volume of the optical element to be tested.

55. The method as claimed in claim 45, further comprising separating the components of defects of the homogeneity of the optical element caused by the two surfaces and the volume of the optical element by virtue of two further measurements being implemented according to the principles of interferometry, including
in a first additional measurement, assigning a first new reference face to a first surface which represents an original light-entry surface of the optical element to be tested, in order to represent the surface defects of this first surface,
in a further additional measurement, rotating the optical element to be tested through 180° and, once again, assigning a reference face to a second surface of the optical element to be tested, in order to represent the surface defects of this second surface,
combining the first additional measurement and the further additional by calculation with the original measurement in order to constitute the homogeneity of the volume of the optical element to be tested.

56. The method as claimed in claim 55, further comprising utilizing the principles of a Fizeau interferometer

57. The method as claimed in claim 56, further comprising utilizing the principles of a Fizeau interferometer
